(19) United States
(12) Patent Application Publication
(10) Pub. No.: US 2026/0154759 A1
(43) Pub. Date: Jun. 4, 2026

(54) Pharmaceutical Manufacturing Information Management Device and Method

(71) Applicant: Hitachi Lndustry & Control Solutions, Ltd., Taito-ku, Tokyo (JP)

(72) Inventors: Taisei MIYAZAKI, Tokyo (JP); Kojiro TOMOTSUNE, Tokyo (JP)

(21) Appl. No.: 19/294,415

(22) Filed: Aug. 8, 2025

(30) Foreign Application Priority Data
Nov. 29, 2024 (JP) 2024-208072

(51) Int. Cl. G06Q 50/04; G06F 16/2458

(52) U.S. Cl. CPC G06Q 50/04; G06F 16/2471

(57) ABSTRACT

A pharmaceutical manufacturing information management device is capable of accessing multiple databases. The device includes: a searcher to search for related information items, when an information item is selected from results of searching information items related to pharmaceutical manufacturing and stored across multiple database servers, as information items related to the selected information item, and a display controller to display the related information items. The searcher searches one or more database servers of the multiple database servers, depending on the selected information item, for the related information items.

### CROSS-REFERENCE TO RELATED APPLICATION

This application claims the benefit of priority under 35 U.S.C. § 119 to Japanese Patent Application No. 2024-208072 filed on Nov. 29, 2024, the entire contents of which are incorporated herein by reference.

### TECHNICAL FIELD

The present invention relates to a pharmaceutical manufacturing information management device and method for managing data pertaining to pharmaceutical manufacturing.

### BACKGROUND ART

Data (information) pertaining to pharmaceutical manufacturing is vast and interrelated with one another. Data to be managed, relationships between data, and even procedures for accessing the data vary depending on pharmaceutical manufacturers. Accordingly, screen display programs of packaged pharmaceutical manufacturing information management products are modified to provide management systems tailored to individual pharmaceutical manufacturers. Note that an access procedure means a way to access one piece of data (information) from another, such as accessing test data from inventory data in which testing has been executed for the inventory items.

Meanwhile, regulations in the pharmaceutical manufacturing field (GMP: Good Manufacturing Practice) require that various data related to manufacturing be retained for 5 to 10 years in principle after the product's expiration date. The retention period varies depending on the type of data and the type of manufactured product, and particularly high-risk pharmaceuticals and biopharmaceuticals require even longer data retention periods.

Thus, pharmaceutical manufacturing is required to retain data for a long time and refer to it as needed. Even at the time of upgrades or hardware updates of a system managing the data, the old system must be retained in isolation. This leads to difficulties in accessing old data and strains on user resources.

In addition, when both old and new databases are used, it is required during audits to collect data (information) pertaining to pharmaceutical manufacturing scattered across both old and new systems. To reduce this workload, it is desirable to be able to access both the old and new databases from the new system and display the information with the new system and issue reports. This requires a screen display function capable of flexibly dealing with different data structures for each pharmaceutical manufacturer.

Techniques for customizing screens by pharmaceutical manufacturers include an invention disclosed in Japanese Patent Application Publication No. 2015-162122 (hereinbelow, referred to as Patent Document 1). This invention provides a system for creating database reference screens used to create screens for referring to database information and including an information manager, a screen configuration modifier, and a screen provider. The information manager manages item information indicating items managed in a database, search method information defining search methods for pieces of the item information, search condition information defining conditions for searching the database based on the search method, and result display method information defining methods for displaying search results extracted from the database based on the search method. The screen configuration modifier modifies configuration of a search screen for searching the database according to the search method information and search condition information, and configuration of a result display screen for displaying the search results according to the result display method. The screen provider provides the search screen and result display screen, which have been modified by the screen configuration modifier, to a user terminal for display.

### SUMMARY OF THE INVENTION

### Problems to Be Solved

Pharmaceutical manufacturers can use the invention described in Patent Document 1 to set screen configurations and data search conditions, to access data according to their desired procedures. However, the invention described in Patent Document 1 does not support access to the old database. The present invention has been devised in view of such circumstances and is intended to provide a pharmaceutical manufacturing information management device and a pharmaceutical manufacturing information management method capable of accessing multiple databases.

### Solution to Problems

To solve the above-identified problems, a pharmaceutical manufacturing information management device according to the present invention includes: a searcher to search, when an information item is selected from results of searching information items that are stored across multiple database servers and pertain to pharmaceutical manufacturing, for one or more related information items related to the selected information item, and a display controller to display the one or more related information items, wherein the searcher searches one or more database servers of the multiple database servers, depending on the selected information item, for the one or more related information items.

### Advantageous Effects of the Invention

The present invention provides a pharmaceutical manufacturing information management device and method which are capable of accessing multiple databases. Other problems, configurations, and advantageous effects are made clear in the following description of one or more embodiments.

### BRIEF DESCRIPTION OF THE DRAWINGS

FIG. 1 shows a screen layout of a pharmaceutical manufacturing information management screen displayed by a pharmaceutical manufacturing information management device according to the present embodiment;

FIG. 2 is a flowchart of a procedure acquiring pharmaceutical manufacturing information, according to the present embodiment;

FIG. 3 is a functional block diagram of the pharmaceutical manufacturing information management device according to the present embodiment;

FIG. 4 shows a data structure of screen setup information according to the present embodiment;

FIG. 5 shows a data structure of item information according to the present embodiment;

FIG. 6 is a flowchart of a pharmaceutical manufacturing information management screen process according to the present embodiment;

FIG. 7 shows a screen layout of a manufacturing information screen according to a modification of the present embodiment;

FIG. 8 shows a screen layout of an inventory screen according to the modification of the present embodiment;

FIG. 9 shows a data structure of a screen setup information according to the modification of the present embodiment; and

FIG. 10 shows a hardware configuration of an exemplary computer to implement functions of the pharmaceutical manufacturing information management device according to the embodiment.

### DETAILED DESCRIPTION OF EMBODIMENTS

### Procedure of using Pharmaceutical Manufacturing Information Management Device

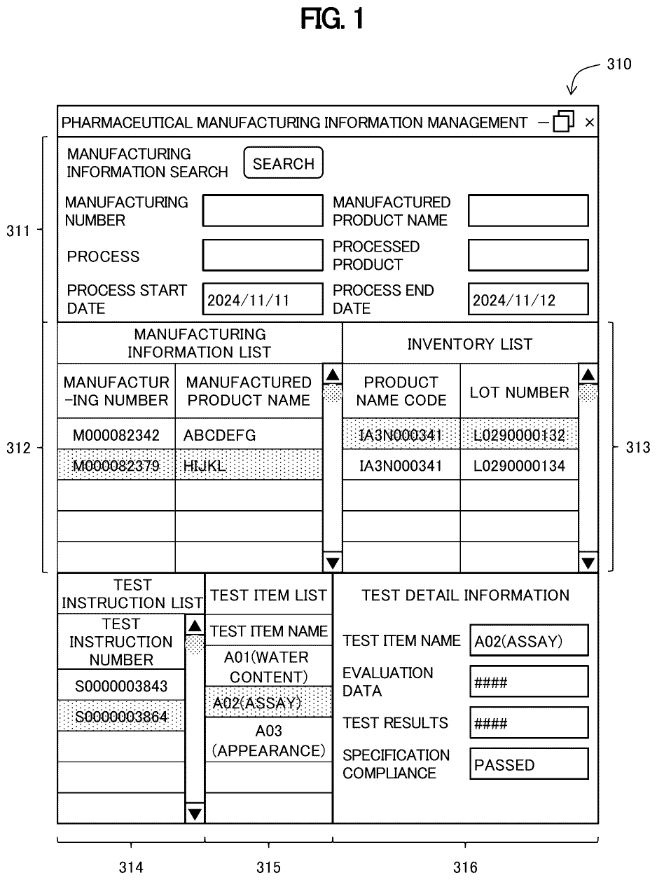

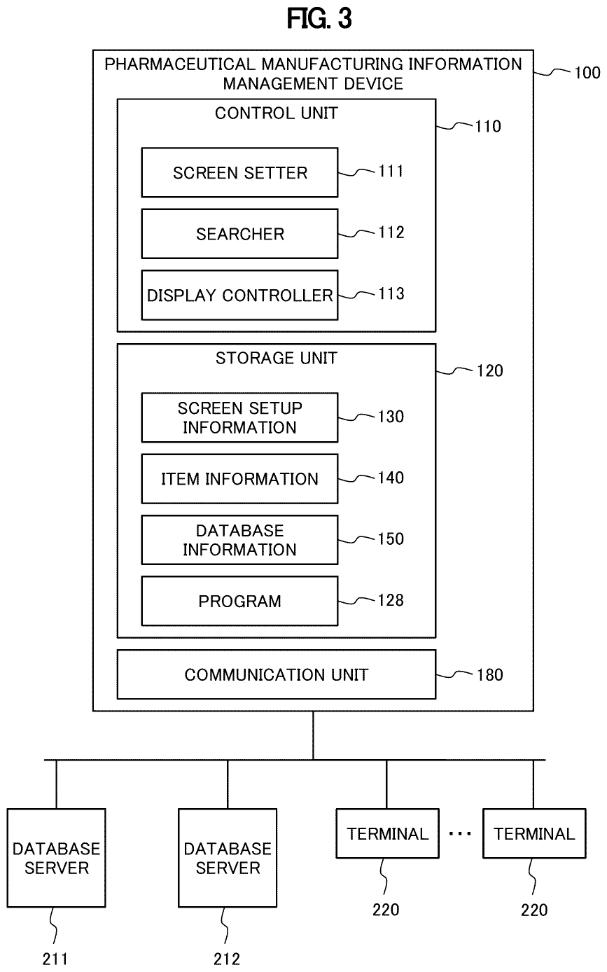

Prior to description of configuration of a pharmaceutical manufacturing information management device 100 (see FIG. 3 to be described below) according to an embodiment to implement the present invention, a description is given of a procedure of using the pharmaceutical manufacturing information management device 100. FIG. 1 shows a screen layout of a pharmaceutical manufacturing information management screen 310 displayed by the pharmaceutical manufacturing information management device 100 according to the present embodiment. The pharmaceutical manufacturing information management screen 310 is provided at an upper level thereof with a manufacturing information search area 311. The pharmaceutical manufacturing information management screen 310 is provided at a middle level thereof with a manufacturing information list area 312 and an inventory list area 313. The pharmaceutical manufacturing information management screen 310 is provided at a lower level thereof with a test instruction list area 314, a test item list area 315, and a test detail information area 316.

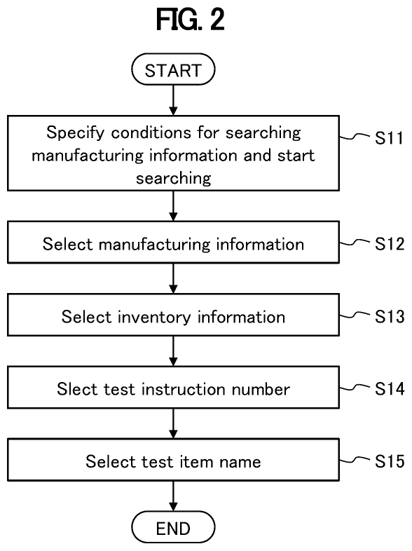

FIG. 2 is a flowchart of a procedure of acquiring pharmaceutical manufacturing information, according to the present embodiment. A description is given of a procedure for a user of the pharmaceutical manufacturing information management device 100 to access test information of a manufactured product (product) based on a manufacturing process date, with reference to FIGS. 1 and 2.

In step S11, the user specifies conditions for searching manufacturing information and starts searching. Specifically, the user enters the search conditions in the manufacturing information search area 311 and hits a “SEARCH” button. Then, a list of manufacturing numbers and manufactured product names, as identification information of manufacturing information matching the search conditions, is displayed in the manufacturing information list area 312. In FIG. 1, a start date and an end date of a manufacturing process are specified as the search conditions. The manufacturing numbers and manufactured product names are also displayed as manufacturing information of the search results.

In step S12, the user selects a piece of the manufacturing information. Then, a product name code and a lot number of inventory information for (related to) the piece of the manufacturing information are displayed in the inventory list area 313. In FIG. 1, the selected piece of the manufacturing information (“M000082379” and “HIJKL”) is highlighted (hatched).

In step S13, the user selects a piece of the inventory information. Then, test instruction numbers of test instructions for (related to) the piece of the inventory information is displayed in the test instruction list area 314. In FIG. 1, the selected piece of the inventory information (“IA3N000341” and “L0290000132”) is highlighted.

In step S14, the user selects a test instruction number. Then, test item names of tests for (related to) the test instruction number is displayed in the test item list area 315. In FIG. 1, the selected test instruction number (“S0000003864”) is highlighted.

In step S15, the user selects a test item name. Then, test detail information of a test item for (related to) the test item name is displayed in the test detail information area 316. In FIG. 1, the selected test item name (“A02 (assay)”) is highlighted.

As described so far, the user can specify the manufacturing conditions to search manufacturing information, and follow a sequence of the inventory information, test instruction number, and test item name, to access the test detail information. Hereinbelow, the manufacturing information and inventory information respectively displayed in the manufacturing information list area 312 and inventory list area 313, as the search results, are referred to as information items or simply items. For example, there are two information items or items displayed in the test instruction list area 314, and the test instruction numbers are “S0000003843” and “S0000003864.” Note that when an information item is selected to search for one or more information items related to the former, an information item which has been selected is also described as a selected information item, and an information item related to the former is also described as a related information item.

Procedures of accessing pharmaceutical manufacturing information are not limited to the one described above and may include the following ones:
1) raw material receipt <—> raw material inventory <—> raw material testing;
2) raw material inventory <—> stock movement <—> manufacturing <—> testing <—> shipping decision <—> shipping;
3) inventory <—> testing <—> manufacturing;
4) manufacturing equipment <—> manufacturing;
5) manufacturing equipment <—> equipment testing; and
6) manufacturing <—> deviation.

For example, in procedure 1), the user accesses information items pertaining to pharmaceutical manufacturing as follows. First, the user specifies conditions for searching raw material receipt information and starts searching, to have a list of raw material receipt information displayed. Next, the user selects a raw material receipt information item, to have related raw material inventory information displayed. Then, the user selects a raw material inventory information item, to have related raw material testing information displayed.

Additionally, procedure 1) also shows reverse accessing. First, the user specifies conditions for searching raw material testing information and starts searching, to have a list of raw material testing information displayed. Next, the user selects a raw material testing information item, to have related raw material inventory information displayed. Then, the user selects a raw material inventory information item, to have related raw material receipt information displayed. For procedure 3), the user can access inventory information from manufacturing information or vice versa, as shown in FIG. 1.

Data such as on inventory, testing, and manufacturing is stored in one or more database servers (see database servers 211 and 212 in FIG. 3, to be described below), and there can be more than one database server. Information items pertaining to pharmaceutical manufacturing may be stored across multiple database servers depending on creation dates of the information items (data). Note that the testing in procedure 2) means testing of manufactured products, such as the test instructions, test items, and test detail information shown in FIG. 1.

As described above, combinations of the selected information item and related information item can be one of those listed below:
the selected information item is manufacturing information of a pharmaceutical product, and the related information item is inventory information of the pharmaceutical product;
the selected information item is inventory information of a pharmaceutical product, and the related information item is manufacturing information of the pharmaceutical product;
the selected information item is inventory information of a pharmaceutical product, and the related information item is testing information of the pharmaceutical product;
the selected information item is testing information of a pharmaceutical product, and the related information item is inventory information of the pharmaceutical product;

(cont.)
the selected information item is receipt information of raw materials of a pharmaceutical product, and the related information item is inventory information of raw materials of the pharmaceutical product;
the selected information item is inventory information of raw materials of a pharmaceutical product, and the related information item is receipt information of raw materials of the pharmaceutical product;
the selected information item is inventory information of raw materials of a pharmaceutical product, and the related information item is testing information of raw materials of the pharmaceutical product;
the selected information item is testing information of raw materials of a pharmaceutical product, and the related information item is inventory information of raw materials of the pharmaceutical product;

(cont.)
the selected information item is inventory information of raw materials of a pharmaceutical product, and the related information item is stock movement information of raw materials of the pharmaceutical product;
the selected information item is stock movement information of raw materials a pharmaceutical product, and the related information item is inventory information of raw materials of the pharmaceutical product;
the selected information item is stock movement information of raw materials of a pharmaceutical product, and the related information item is manufacturing information of the pharmaceutical product;
the selected information item is manufacturing information of a pharmaceutical product, and the related information item is stock movement information of the raw materials of the pharmaceutical product;

(cont.)
the selected information item is manufacturing information of a pharmaceutical product, and the related information item is testing information of the pharmaceutical product;
the selected information item is testing information of a pharmaceutical product, and the related information item is manufacturing information of the pharmaceutical product;
the selected information item is testing information of a pharmaceutical product, and the related information item is shipping decision information of the pharmaceutical product;
the selected information item is shipping decision information of a pharmaceutical product, and the related information item is testing information of the pharmaceutical product;

(cont.)
the selected information item is shipping decision information of a pharmaceutical product, and the related information item is shipping information of the pharmaceutical product;
the selected information item is shipping information of a pharmaceutical product, and the related information item is shipping decision information of the pharmaceutical product;
the selected information item is manufacturing equipment information of a pharmaceutical product, and the related information item is manufacturing information of the pharmaceutical product;
the selected information item is manufacturing information of a pharmaceutical product, and the related information item is manufacturing equipment information of the pharmaceutical product;

(cont.)
the selected information item is equipment information of manufacturing equipment, and the related information item is equipment testing information of the manufacturing equipment;
the selected information item is equipment testing information of manufacturing equipment, and the related information item is equipment information of the manufacturing equipment;
the selected information item is manufacturing information of a pharmaceutical product, and the related information item is deviation information of the pharmaceutical product; and
the selected information item is deviation information of a pharmaceutical product, and the related information item is manufacturing information of the pharmaceutical product.

### Configuration of Pharmaceutical Manufacturing Information Management Device

FIG. 3 is a functional block diagram of the pharmaceutical manufacturing information management device 100 according to the present embodiment. The pharmaceutical manufacturing information management device 100 is a computer and includes a control unit 110, a storage unit 120, and a communication unit 180. The communication unit 180 includes a communication device and can send and receive data from/to database servers 211, 212 and terminals 220. The terminal 220 is used by a user of the pharmaceutical manufacturing information management device 100 to access pharmaceutical manufacturing information.

### Configuration of Database Server

The database servers 211 and 212 store data (information) pertaining to pharmaceutical manufacturing. In the following description, suppose there are two database servers 211 and 212 depending on creation dates of the data. For example, data created before a certain point in time is stored in the database server 211, while data created after that point in time is stored in the database server 212. Hereinafter, a description is given based on an assumption that “a certain point in time” is Jan. 1, 2024. This means that old data before Jan. 1, 2024, is stored in the database server 211, while new data on and after this date is stored in the database server 212 due to an update of the database server.

The database servers 211 and 212 store information such as on receipt of raw materials, inventory of raw materials, testing of raw materials, inventory of raw materials, stock movement, manufacturing, testing, and shipping. Additionally, these pieces of information is stored in association with information for search and access procedures. Examples are shown below.

As shown in the manufacturing information search area 311 (see FIG. 1), manufacturing information can be searched with conditions such as a manufacturing number, a manufactured product name, a process, a processed product, a process start date, and a process end date. Accordingly, the manufacturing information is stored across the database servers 211 and 212 in association with information such as a manufacturing number and a process.

Also, as shown in the manufacturing information list area 312 and inventory list area 313, inventory information can be accessed from manufacturing information, and inventory information and manufacturing information are stored across the database servers 211 and 212, with one associated with the other. For example, manufacturing information is associated with inventory information of a manufactured product produced in the manufacturing (manufacturing process) indicated by the manufacturing information. Conversely, inventory information is associated with manufacturing information of the manufacturing (manufacturing process) which manufactured the manufactured product on inventory indicated by the inventory information.

As shown in procedure “2) raw material inventory <—> stock movement <—> manufacturing <—> testing <—> shipping decision <—> shipping,” manufacturing information and testing information can be accessed from each other, and the manufacturing and testing are stored across the database servers 211 and 212, with one associated with the other. Note that manufacturing and testing are executed at the same period of time, so that manufacturing information and testing information are stored in the same database server 211 or 212. For example, if a certain information item of manufacturing information is in the database server 211, testing information related (corresponding) to the information item has its information item(s) also in the database server 211.

Depending on the related information (information item related to a certain information item), an information item and information related to the information item may be stored in the different database servers 211 and 212 from each other. For example, suppose a first raw material used in manufacturing a certain manufactured product has been received before Jan. 1, 2024, and thus inventory information thereof is in the database server 211. Likewise, suppose a second raw material has been received after Jan. 1, 2024, and thus inventory information thereof is in the database server 212. In such a case, the inventory information of raw materials related to the stock movement information related to the manufacturing information in procedure “2) raw material inventory <—> stock movement <—> manufacturing <—> testing <—> shipping decision <—> shipping” is stored in both of the database servers 211 and 212. Specifically, inventory information of the first raw material is stored in the database server 211, and the inventory information of the second raw material is stored in the database server 212.

In this manner, there are cases where an information item (selected information item) and an information item (related information item) related to the selected information item are stored in the same database server, and cases where the selected information item and the related information item are stored across multiple database servers including cases of them being stored in different database servers, depending on the related information. Thus, when a related information item for an information item is searched, it is necessary to switch one or more database servers to search, depending on the relationship between the selected information item and the related information item, between the same database server as the one storing the information item and database servers inclusive of other ones. Hereinbelow, a mode of a selected information item and one or more related information items related to the selected information item being stored in the same database server is sometimes referred to as Type I (coexistence). Likewise, a mode of the former and the latter being stored across multiple database servers (database servers 211 and 212) is sometimes referred to as Type II (non-coexistence).

### Pharmaceutical Manufacturing Information Management Device: Storage Unit

The storage unit 120 is composed of storage devices such as a ROM (Read Only Memory), a RAM (Random Access Memory), and an SSD (Solid State Drive). The storage unit 120 stores screen setup information 130, item information 140, database information 150, and a program 128. Note that various contents stored in the storage unit 120 may be retrieved as needed from external storage devices such as cloud servers. The program 128 includes a description of processing by functional units in the control unit 110, to be described below.

### Storage Unit: Screen Setup Information

FIG. 4 shows a data structure of the screen setup information 130 according to the present embodiment. The screen setup information 130 includes information pertaining to a structure of a screen displayed by the pharmaceutical manufacturing information management device 100. For example, the screen setup information 130 includes information regarding the pharmaceutical manufacturing information management screen 310 (see FIG. 1), pertaining to positions and sizes of areas included in the screen, such as the manufacturing information search area 311, and information items to be displayed (display items).

The screen setup information 130 also includes processing when an information item displayed in the area is selected, as item-selection-time processing. For example, manufacturing information and inventory information in the pharmaceutical manufacturing information management screen 310 are created at the same period of time and thus stored in the same database server (Type I). Accordingly, when an information item of the displayed manufacturing information is selected, item-selection-time processing in the manufacturing information list area 312 includes processing to search the same database server as the one storing the information item for inventory information, which is related to the information item, and to retrieve and display the results in the inventory list area 313.

As described above, “raw material inventory” related to “stock movement” pertaining to “manufacturing” in procedure “2) raw material inventory <—> stock movement <—> manufacturing <—> testing <—> shipping decision <—> shipping” is stored in both of the database servers 211 and 212 (Type II). Accordingly, when the raw material inventory is accessed from the stock movement information, where the former is related to the latter, it is necessary to search both of the database servers 211 and 212. Item-selection-time processing in the stock movement information area (not shown) would include processing to search both of the database servers 211 and 212, when an information item of stock movement information is selected, for raw material inventory information related to the information item, and to retrieve and display the results in the raw material inventory list area (not shown).

Note that search-related processing of item-selection-time processing to search either one (Type I) or both (Type II) of the database servers 211 and 212 for inventory information related to the selected item and to acquire the results is also described as search processing. The search processing may include search location information indicating the database(s) to search being the same as the one storing the selected item (Type I, coexistence) or both of the database servers 211 and 212 (Type II, non-coexistence), as well as a search command (query).

### Storage Unit: Item Information

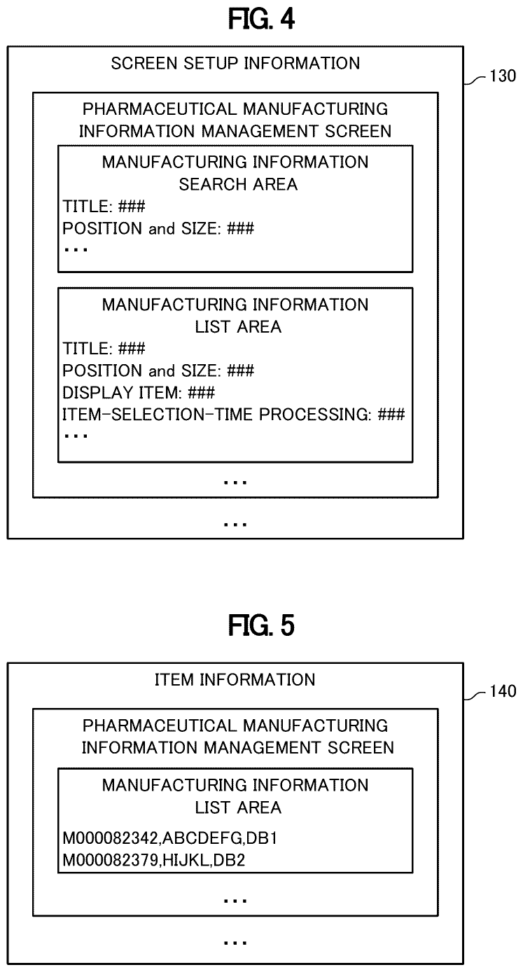

FIG. 5 shows a data structure of the item information 140 according to the present embodiment. The item information 140 includes information on the information items of the search results displayed on the screen by the pharmaceutical manufacturing information management device 100. For example, the item information 140 regarding the pharmaceutical manufacturing information management screen 310 (see FIG. 1) includes information on information items to be displayed in the manufacturing information list area 312, inventory list area 313, test instruction list area 314, and test item list area 315.

The information pertaining to the information items of the manufacturing information to be displayed in the manufacturing information list area 312 includes a manufacturing number and a manufactured product name of each displayed information item, as well as identification information of the database server 211 or 212 containing the information item. For example, suppose a manufactured product name has been specified in the pharmaceutical manufacturing information management screen 310 (see FIG. 1) to search manufacturing information. Then, the manufacturing information search area 311 would display information items of manufacturing information before Jan. 1, 2024, and those after the said date. In this case, the item information 140 includes identification information of the database server 211 for information items before the said date, and identification information of the database server 212 for information items after the said date. Note that “M000082342” is a manufacturing number, “ABCDEFG” is a manufactured product name, and “DB1” is identification information of the database server 211 in FIG. 5. The identification information of the database servers 211 and 212 is not displayed on the screen (see FIG. 1).

### Storage Unit: Database Information

The storage unit 120 is still described with reference back to FIG. 3. The database information 150 is stored with identification information and addresses the database servers 211 and 212, and authentication information for accessing the database servers 211 and 212 so as to be associated with each other. The database information 150 may also store other information, such as a database type of database server.

### Pharmaceutical Manufacturing Information Management Device: Control Unit

The control unit 110 is composed of a CPU (Central Processing Unit) and includes a screen setter 111, a searcher 112, and a display controller 113.

### Control Unit: Screen Setter

The screen setter 111 receives information pertaining to a structure of a screen displayed by the pharmaceutical manufacturing information management device 100, as instructed by an administrator of the pharmaceutical manufacturing information management device 100. The screen setter 111 stores the received screen structure information in the screen setup information 130.

As described above, the pharmaceutical manufacturing information management device 100 includes a screen setter 111 to store in the storage unit 120 a position and a size of a selected-information-item list display area for displaying a list of selected information items and a position and a size of a related-information-item list display area for displaying a list of related information items on a screen to display the information items, and the search location information indicating a relationship between the selected information item and the one or more related information items (see item-selection-time processing in FIG. 4).

### Control Unit: Searcher

The searcher 112 searches the database servers 211 and/or 212, when a user has specified search conditions and instructed searching, for information items to match the search conditions and acquires the results. The searcher 112 also accesses and searches the database servers 211 and/or 212 for related information items related to the selected information item and acquires the results. The searcher 112 stores the search results in the item information 140, along with the identification information of the searched database servers 211 and/or 212.

The search processing is included in the item-selection-time processing (see FIG. 4) in the screen setup information 130. The search processing also includes search location information. For example, the search location information for the manufacturing information list area 312 is Type I. When an information item of manufacturing information displayed in the manufacturing information list area 312 is selected, the same database server as the one storing the information item (selected information item) is searched (Type I) for inventory information related to the information item. When the search location information included in the search processing indicates Type II, the searcher 112 searches both of the database servers 211 and 212.

### Control Unit: Display Controller

The display controller 113 creates a screen based on the screen setup information 130 and item information 140 and sends it to the terminal 220 (displays the screen on a display of the terminal 220). Hereinbelow, processing by the searcher 112 and display controller 113 is described using the pharmaceutical manufacturing information management screen 310 as an example.

### Control Unit: Example of Processing by Searcher and Display Controller

First, the display controller 113 displays an initial screen of the pharmaceutical manufacturing information management screen 310. The initial screen is a screen where no information items are displayed in any areas, such as the manufacturing information search area 311 and manufacturing information list area 312.

For example, suppose a process start date and process end date have been specified and SEARCH for manufacturing information has been instructed, as shown in the manufacturing information search area 311 in FIG. 1. Then, the searcher 112 searches the database servers 211 and 212 for manufacturing information to match the process start date and process end date. The searcher 112 stores information items as the search results in the item information 140, along with identification information of the database servers 211 and 212 storing the information items. The display controller 113 displays, in the manufacturing information list area 312, manufacturing numbers and manufactured product names of the information items in the item information 140 (see the manufacturing information list area 312 in FIG. 1).

Next, suppose the user has selected an information item (selected information item) with the manufacturing number of “M000082379” and manufactured product name of “HIJKL” displayed in the manufacturing information list area 312. Then, the searcher 112 refers to the search location information (Type I) included in the item-selection-time processing of the manufacturing information list area 312 in the screen setup information 130 and acquires identification information of the database server storing the selected information item. Next, the searcher 112 searches the database server corresponding to the identification information for information items (related information items) in the inventory information, as related information. The searcher 112 stores the information items as the search results in the item information 140, along with the identification information of the database servers 211 and 212 storing the information items. The display controller 113 displays, in the inventory list area 313, product name codes and lot numbers of the inventory information in the item information 140 (see the inventory list area 313 in FIG. 1).

In this way, the user can refer to (access) related information one after another, such as with manufacturing information searched and acquired by specifying conditions, followed by inventory information, followed by test instructions, test items, and test detail information.

As explained above, the pharmaceutical manufacturing information management device 100 includes the searcher 112 to search, when an information item is selected from results of searching information items that are stored across the database servers 211 and 212 and pertain to pharmaceutical manufacturing, for one or more related information items related to the selected information item. The searcher 112 searches either one or both of the multiple database servers 211 and 212, depending on the selected information item, for the one or more related information items. The pharmaceutical manufacturing information management device 100 also includes the display controller 113 to display the one or more related information items.

The searcher 112 refers to the search location information indicating coexistence (Type I) as a relationship of the selected information item and the one or more related information items related to the selected information item being stored in the same database server 211 or 212, or non-coexistence (Type II) as a relationship of the selected information item and the one or more related information items not being always stored in the same database server 211 or 212, and searches the same database server, as the one storing the selected information item, for the one or more related information items when the search location information indicates coexistence and searches multiple database servers for the one or more related information items when the search location information indicates non-coexistence.

The searcher 112 searches one or more database servers, depending on the search location information (see the item-selection-time processing in FIG. 4), for one or more related information items related to the selected information item displayed and selected in the selected-information-item list display area. The display controller 113 displays the one or more related information items as the search results in the related-information-item list display area.

### Pharmaceutical Manufacturing Information Management Screen Process

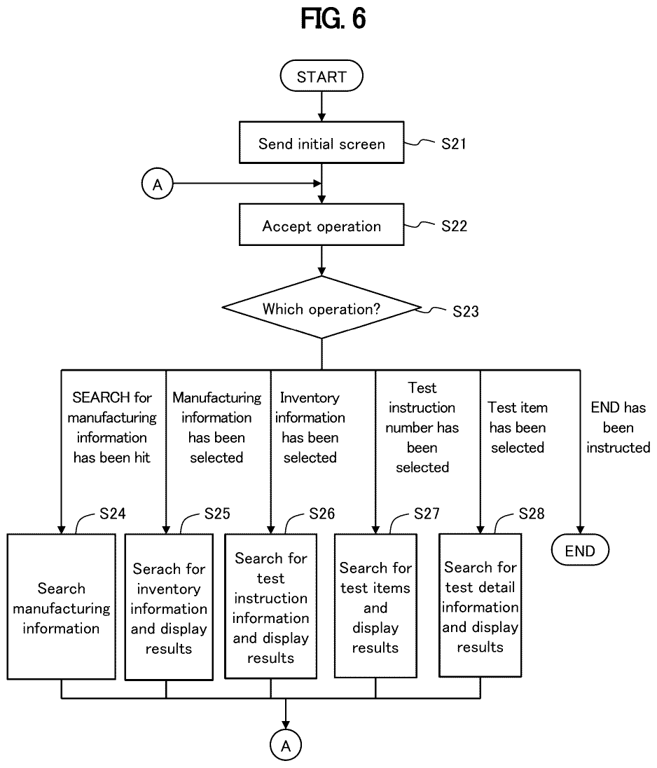

FIG. 6 is a flowchart of a pharmaceutical manufacturing information management screen process according to the present embodiment. A screen process related to the pharmaceutical manufacturing information management screen 310 is described with reference to FIG. 6.

In step S21, the display controller 113 sends the initial screen of the pharmaceutical manufacturing information management screen 310 to the terminal 220. In step S22, the display controller 113 accepts user operation on the pharmaceutical manufacturing information management screen 310.

In step S23, when the operation accepted in step S22 is operation to specify a manufacturing information search condition in the manufacturing information search area 311 and search for manufacturing information (see step S11 in FIG. 2) (manufacturing information search has been selected in step S22), the display controller 113 proceeds processing to step S24. When the operation has selected an information item of the manufacturing information in the manufacturing information list area 312 (see step S12) (manufacturing information has been selected in step S22), the display controller 113 proceeds processing to step S25.

When the operation has selected an information item of the inventory information in the inventory list area 313 (see step S13) (inventory information has been selected in step S22), the display controller 113 proceeds processing to step S26. When the operation has selected an information item of the test instruction number in the test instruction list area 314 (see step S14) (test instruction number has been selected in step S22), the display controller 113 proceeds processing to step S27.

When the operation has selected an information item of the test item in the test item list area 315 (see step S15) (test item has been selected in step S22), the display controller 113 proceeds processing to step S28. When the operation has instructed End (to press mark “X” at the top right of the pharmaceutical manufacturing information management screen 310) (End has been instructed in step S22), the display controller 113 ends the pharmaceutical manufacturing information management screen process.

In step S24, the searcher 112 searches the database servers 211 and 212 for manufacturing information to match the specified manufacturing information search conditions and stores the results in the item information 140. The display controller 113 displays, in the manufacturing information list area 312, the manufacturing information in the item information 140. Here, the manufacturing information includes information items stored in the database server 211 and information items stored in the database server 212.

In step S25, the searcher 112 searches for inventory information as related information according to the search processing (search location information tells Type I) included in the item-selection-time processing in the screen setup information 130 pertaining to an information item of the selected manufacturing information, and stores information items as the search results in the item information 140. Subsequently, the display controller 113 displays, in the inventory list area 313, the information items of the inventory information in the item information 140.

The selected information item of manufacturing information is in the manufacturing information search area 311. Thus, the searcher 112 searches the same database server, as the one storing the selected information item of manufacturing information, for one or more information items of the inventory information, according to the search processing (Type I) included in the item-selection-time processing of the manufacturing information search area 311.

In step S26, the searcher 112 searches for test instruction information as related information according to the search processing (Type I) included in the item-selection-time processing in the screen setup information 130 pertaining to an information item of the selected inventory information, and stores information items of the search results in the item information 140. Subsequently, the display controller 113 displays, in the test instruction list area 314, the information items of the test instruction information in the item information 140.

In step S27, the searcher 112 searches for test items as related information according to the search processing (Type I) included in the item-selection-time processing in the screen setup information 130 pertaining to an information item of the selected test instruction number, and stores information items of the search results in the item information 140. Subsequently, the display controller 113 displays, in the test item list area 315, the information items of the test items in the item information 140.

In step S28, the searcher 112 searches for test detail information as related information according to the search processing (Type I) included in the item-selection-time processing in the screen setup information 130 pertaining to the selected test item, and stores information items of the search results in the item information 140. Subsequently, the display controller 113 displays, in the test detail information area 316, the information items of the test detail information in the item information 140.

### Features of Pharmaceutical Manufacturing Information Management Device

Using the pharmaceutical manufacturing information management device 100 allows the administrator to create a screen for managing pharmaceutical manufacturing information. For example, the administrator sets areas included in the screen, positions and sizes of the areas, items displayed in the areas, and processing when the items displayed in the areas are selected, to create the screen.

After the screen has been created, a user can search for desired information, select an item in the search results, and access information (related information items) related to the selected items (selected information items) one after another. For example, the user can use the pharmaceutical manufacturing information management screen 310 to set conditions for manufacturing information to access, execute SEARCH, and access inventory information, test instruction number, test items, and test details in order, from the manufacturing information of the search results.

Information items are stored across multiple database servers 211 and 212, and the pharmaceutical manufacturing information management device 100 selects one or more database servers, depending on the selected information item, and searches for one or more related information items. Thus, the user does not need to be aware of the database servers 211 and 212 to search.

Using the pharmaceutical manufacturing information management device 100 allows for managing pharmaceutical manufacturing information for a long time. Even if the hardware or software of the database servers 211 and 212 is updated, the data can be transferred to the updated database server (e.g. ; the database server 211 storing old data), to allow for accessing related information stored before the update in the same way as related information stored after the update.

### Modification: Access Order

In the above embodiment, an order of accessing information items is set in the screen setup information 130 (see FIG. 4). For example, an information item to be accessed next is uniquely determined by setup in the pharmaceutical manufacturing information management screen 310 (see FIG. 1), depending on the information item, such as the order of manufacturing information, inventory, test instructions, test items, and test detail information.

In contrast, a type of information item to be accessed next, after an information item has been selected, and related to the selected information item may be made selectable. For example, information items related to manufacturing information include inventory, stock movement, testing, and manufacturing equipment. After selecting an information item of manufacturing information, the user may be allowed to select the related information item to be accessed next from among inventory, stock movement, testing, and manufacturing equipment.

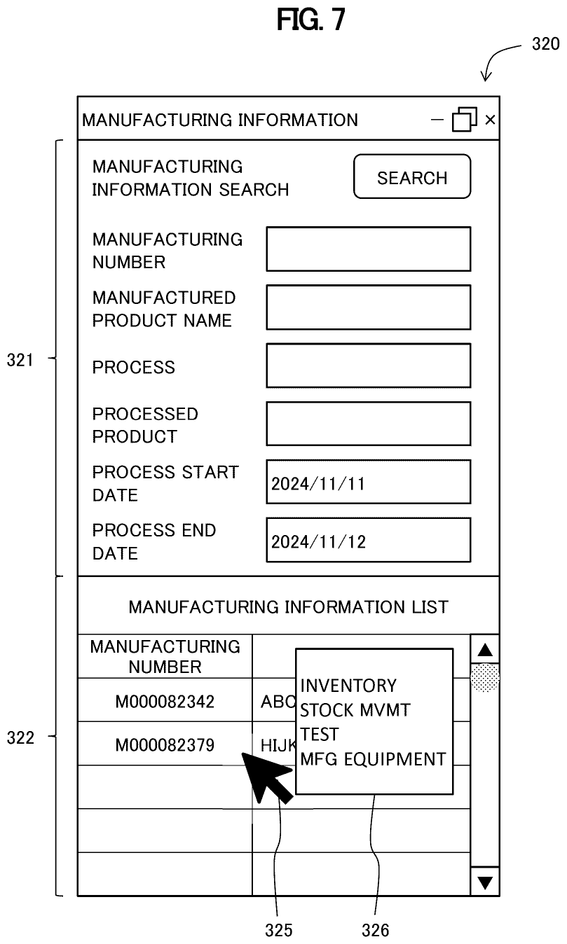

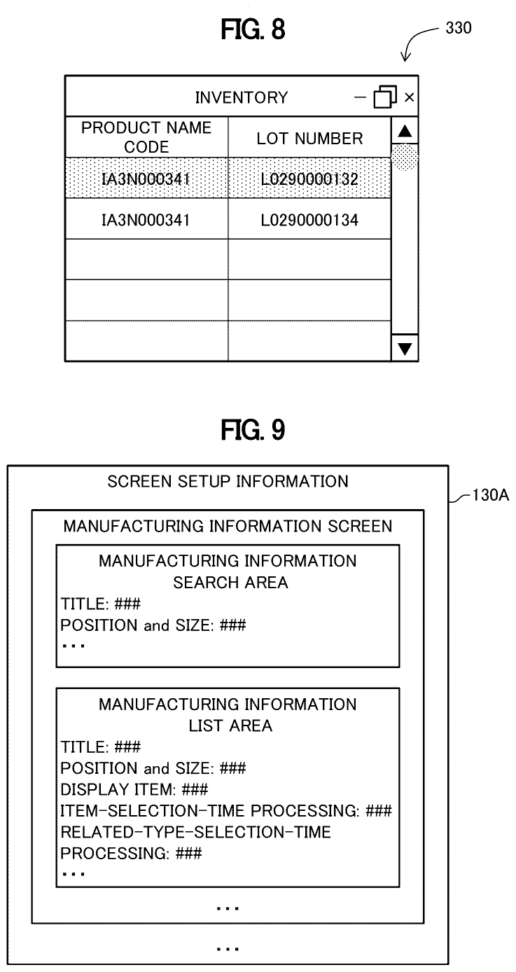

FIG. 7 shows a screen layout of a manufacturing information screen 320 according to a modification of the present embodiment. A manufacturing information search area 321 and a manufacturing information list area 322 of the manufacturing information screen 320 are the same as the manufacturing information search area 311 and manufacturing information list area 312 of the pharmaceutical manufacturing information management screen 310 (see FIG. 1), respectively. In FIG. 7, a user uses a pointer 325 to select a manufacturing number “M000082379” and open a context menu 326. When the user selects a type of related information item to be accessed next from the context menu 326, the selected type of related information item (see FIG. 8 to be described below) is displayed. Here, suppose the user has selected “inventory” as the type of related information item.

FIG. 8 shows a screen layout of an inventory screen 330 according to the modification of the present embodiment. For the information item selected in the manufacturing information screen 320, the inventory screen 330 displays related information items of the type “inventory” selected by the user. Note that the inventory screen 330 also allows the user to select a type of related information item to access next, as with the manufacturing information screen 320.

FIG. 9 shows a data structure of a screen setup information 130A according to the modification of the present embodiment. An item “related-type-selection-time processing” has been added, as compared to the screen setup information 130 (see FIG. 4). This item includes a type of related information item to be displayed in the context menu opened after an information item has been selected, and processing to do. The processing is the same as that in the item-selection-time processing and includes search processing inclusive of search location information and a screen (list display screen for the selected type of related information item) to display the search results.

When a type has been selected, the searcher 112 searches for the selected type of related information item, according to search processing for the selected type included in the item-selection-time processing in the screen setup information 130A, and stores information items of the search results in the item information 140. Subsequently, the display controller 113 displays the information items in the item information 140 on the list display screen for the selected type of related information item.

According to such a pharmaceutical manufacturing information management device of the modification, a user can select a related information item to access after selecting an information item. This increases the degree of freedom in selecting a related information item to access, to allow for efficiently accessing pharmaceutical manufacturing information.

As described above, there are multiple types of related information items related to the selected information item. The searcher 112 searches for the selected type of related information item. The searcher 112 refers to the search location information indicating coexistence as a relationship of the selected information item and the selected type of related information item related to the selected information item being stored in the same database server, or non-coexistence as a relationship of the selected information item and the selected type of related information item not being always stored in the same database server, and searches the same database server, as the one storing the selected information item, for the selected type of related information item when the search location information indicates coexistence, while searches multiple database servers for the selected type of related information item when the search location information indicates non-coexistence.

The pharmaceutical manufacturing information management device 100 includes the screen setter 111 to store in the storage unit 120 a position and a size of the selected-information-item list display screen for displaying a list of the selected information items and a position and a size of the selected-type-of-related-information-item list display screen for displaying a list of the selected type of related information item on a screen to display information items, and the search location information indicating a relationship between the selected information item and the selected type of related information item.

The searcher 112 searches one or more of the multiple database servers, depending on the search location information, for the selected type of related information item related to the selected information item displayed and selected on the selected-information-item list display screen. The display controller 113 displays the selected type of related information item of the search results on the selected-type-of-related-information-item list display screen.

### Hardware Configuration

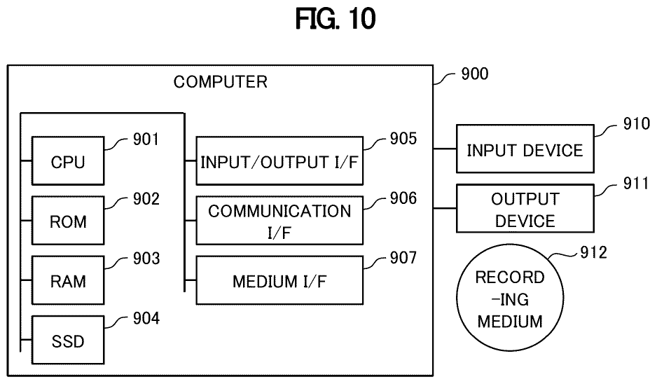

The pharmaceutical manufacturing information management device 100 according to the above-described embodiment is implemented by a computer 900 configured as shown in FIG. 10, for example. FIG. 10 shows a hardware configuration of an exemplary computer 900 to implement the functions of the pharmaceutical manufacturing information management device 100 according to the above-described embodiment. The computer 900 includes a CPU 901, a ROM 902, a RAM 903, an SSD 904, and an input/output interface 905 (described as input/output I/F in FIG. 10). In addition, the computer 900 includes a communication interface 906 (described as communication I/F in FIG. 10) and a medium interface 907 (described as medium I/F in FIG. 10). The computer 900 may include an HDD (Hard Disc Drive) instead of the SSD 904, or may include an HDD in addition to the SSD 904.

The CPU 901 operates based on a program stored in the ROM 902 or SSD 904, to execute control by the control unit 110 in FIG. 3. The ROM 902 stores a boot program executed by the CPU 901 when the computer 900 is started, programs related to hardware of the computer 900, and the like.

The CPU 901 controls input devices 910 such as a mouse and a keyboard and output devices 911 such as a display and printer, via the input/output interface 905. The CPU 901 receives data from the input devices 910 and outputs generated data to the output devices 911, via the input/output interface 905.

The SSD 904 stores programs executed by the CPU 901 and data used by the programs. The communication interface 906 receives data from other devices (e.g., database servers 211 and 212), not shown, via a communication network and outputs it to the CPU 901, and also sends the data generated by the CPU 901 to said other devices via the communication network.

The medium interface 907 retrieves the programs or data stored in a recording medium 912 and outputs them to the CPU 901 via the RAM 903. The CPU 901 loads the programs from the recording medium 912 via the medium interface 907 onto the RAM 903 and executes the loaded programs. The recording medium 912 is an optical recording medium such as a DVD (Digital Versatile Disk), a magneto-optical recording medium such as an MO (Magneto Optical disk), a magnetic recording medium, a conductor memory tape medium, or a semiconductor memory.

For example, when the computer 900 works as the pharmaceutical manufacturing information management device 100 according to the above-described embodiment, the CPU 901 of the computer 900 executes the program 128 (see FIG. 3) loaded onto the RAM 903 to implement the functions of the pharmaceutical manufacturing information management device 100. The CPU 901 retrieves and executes the program from the recording medium 912. In addition, the CPU 901 may retrieve the program from other devices via the communication network or execute the program 128 installed from the recording medium 912 onto the SSD 904.

### LEGEND FOR REFERENCE NUMERALS

100: pharmaceutical manufacturing information management device, 111: screen setter, 112: searcher, 113: display controller, 130: screen setup information, 140: item information, 211; 212: database server, 310: pharmaceutical manufacturing information management screen, 311; 321: manufacturing information search area, 312; 322: manufacturing information list area, 313: inventory list area, 314: test instruction list area, 315: test item list area, and 316: test detail information area.

What is claimed is:

1. A pharmaceutical manufacturing information management device comprising at least one processor configured to execute functions of:
a searcher to search, when an information item is selected from results of searching information items that are stored across multiple database servers and pertain to pharmaceutical manufacturing, for one or more related information items related to the selected information item, and
a display controller to display the one or more related information items,
wherein the searcher searches one or more of the multiple database servers, depending on the selected information item, for the one or more related information items.

2. The pharmaceutical manufacturing information management device according to claim 1, wherein
the searcher refers to search location information indicating coexistence as a relationship of the selected information item and the one or more related information items related to the selected information item being stored in the same database server, or non-coexistence as a relationship of the selected information item and the one or more related information items not being always stored in the same database server, and
searches the same database server, as the one storing the selected information item, for the one or more related information items when the search location information indicates coexistence and
searches multiple database servers for the one or more related information items when the search location information indicates non-coexistence.

3. The pharmaceutical manufacturing information management device according to claim 2, wherein the at least one processor is further configured to execute functions of:
a screen setter to store in a storage unit a position and a size of a selected-information-item list display area for displaying a list of the selected information items and a position and a size of a related-information-item list display area for displaying a list of the one or more related information items on a screen to display the information items, and the search location information indicating a relationship between the selected information item and the one or more related information items,
wherein the searcher searches one or more database servers, depending on the search location information, for one or more related information items related to the selected information item displayed and selected in the selected-information-item list display area, and
the display controller displays the one or more related information items as search results in the related-information-item list display area.

4. The pharmaceutical manufacturing information management device according to claim 1, wherein
there are multiple types of related information items related to the selected information item, and
the searcher searches for the selected type of related information item.

5. The pharmaceutical manufacturing information management device according to claim 4, wherein
the searcher 112 refers to the search location information indicating coexistence as a relationship of the selected information item and the selected type of related information item related to the selected information item being stored in the same database server, or non-coexistence as a relationship of the selected information item and the selected type of related information item not being always stored in the same database server, and
searches the same database server, as the one storing the selected information item, for the selected type of related information item when the search location information indicates coexistence, while searches multiple database servers for the selected type of related information item when the search location information indicates non-coexistence.

6. The pharmaceutical manufacturing information management device according to claim 5, further comprising:
a screen setter to store in a storage unit a position and a size of a selected-information-item list display screen for displaying a list of the selected information items and a position and a size of a selected-type-of-related-information-item list display screen for displaying a list of the selected type of related information item on a screen to display information items, and the search location information indicating a relationship between the selected information item and the selected type of related information item,
wherein
the searcher searches one or more of the multiple database servers, depending on the search location information, for the selected type of related information item related to the selected information item displayed and selected on the selected-information-item list display screen, and
the display controller displays the selected type of related information item of search results on the selected-type-of-related-information-item list display screen.

7. The pharmaceutical manufacturing information management device according to claim 1, wherein
combinations of the selected information items and the related information items can be any one of those listed below:
the selected information item is manufacturing information of a pharmaceutical product, and the related information item is inventory information of the pharmaceutical product;
the selected information item is inventory information of a pharmaceutical product, and the related information item is manufacturing information of the pharmaceutical product;
the selected information item is inventory information of a pharmaceutical product, and the related information item is testing information of the pharmaceutical product;
the selected information item is testing information of a pharmaceutical product, and the related information item is inventory information of the pharmaceutical product;
the selected information item is receipt information of raw materials of a pharmaceutical product, and the related information item is inventory information of raw materials of the pharmaceutical product;
the selected information item is inventory information of raw materials of a pharmaceutical product, and the related information item is receipt information of raw materials of the pharmaceutical product;
the selected information item is inventory information of raw materials of a pharmaceutical product, and the related information item is testing information of raw materials of the pharmaceutical product;
the selected information item is testing information of raw materials of a pharmaceutical product, and the related information item is inventory information of raw materials of the pharmaceutical product;
the selected information item is inventory information of raw materials of a pharmaceutical product, and the related information item is stock movement information of raw materials of the pharmaceutical product;
the selected information item is stock movement information of raw materials a pharmaceutical product, and the related information item is inventory information of raw materials of the pharmaceutical product;
the selected information item is stock movement information of raw materials of a pharmaceutical product, and the related information item is manufacturing information of the pharmaceutical product;
the selected information item is manufacturing information of a pharmaceutical product, and the related information item is stock movement information of the raw materials of the pharmaceutical product;
the selected information item is manufacturing information of a pharmaceutical product, and the related information item is testing information of the pharmaceutical product;
the selected information item is testing information of a pharmaceutical product, and the related information item is manufacturing information of the pharmaceutical product;
the selected information item is testing information of a pharmaceutical product, and the related information item is shipping decision information of the pharmaceutical product;
the selected information item is shipping decision information of a pharmaceutical product, and the related information item is testing information of the pharmaceutical product;
the selected information item is shipping decision information of a pharmaceutical product, and the related information item is shipping information of the pharmaceutical product;
the selected information item is shipping information of a pharmaceutical product, and the related information item is shipping decision information of the pharmaceutical product;
the selected information item is manufacturing equipment information of a pharmaceutical product, and the related information item is manufacturing information of the pharmaceutical product;
the selected information item is manufacturing information of a pharmaceutical product, and the related information item is manufacturing equipment information of the pharmaceutical product;
the selected information item is equipment information of manufacturing equipment, and the related information item is equipment testing information of the manufacturing equipment;
the selected information item is equipment testing information of manufacturing equipment, and the related information item is equipment information of the manufacturing equipment;
the selected information item is manufacturing information of a pharmaceutical product, and the related information item is deviation information of the pharmaceutical product; and
the selected information item is deviation information of a pharmaceutical product, and the related information item is manufacturing information of the pharmaceutical product.

8. A pharmaceutical manufacturing information management method comprising:
searching, when an information item is selected from results of searching information items that are stored across multiple database servers and pertain to pharmaceutical manufacturing, for one or more related information items related to the selected information item, and
displaying the one or more related information items,
wherein one or more of the multiple database servers are searched in said searching for one or more related information items, depending on the selected information item, for the one or more related information items.
